(19) United States
(12) Patent Application Publication
(10) Pub. No.: US 2021/0400558 A1
(43) Pub. Date: Dec. 23, 2021

(54) Wireless Device, Management Server and Methods Therein for Determining Transmission of Uplink Data

(71) Applicant: Telefonaktiebolaget LM Ericsson (publ), Stockholm (SE)

(72) Inventors: Ari KERÄNEN, Helsinki (FI); Tuomas TIRRONEN, Helsinki (FI)

(21) Appl. No.: 17/292,037

(22) PCT Filed: Nov. 12, 2018
(86) PCT No.: PCT/EP2018/080958

§ 371 Date: May 7, 2021

(51) Int. Cl. H04W 36/32; H04W 36/00; H04W 36/30; H04W 36/08

(52) U.S. Cl. CPC H04W 36/32; H04W 36/08; H04W 36/30; H04W 36/00837

(57) ABSTRACT

A wireless device (10), a management server (8) and methods performed therein are provided. The method performed by the wireless device (10) comprises: obtaining (S210), at an application layer, information associated with a wireless coverage provided by a radio network node (12) for the wireless device (10); and determining (S220), at the application layer, a transmission operation of uplink data based on the obtained information.

### TECHNICAL FIELD

Embodiments herein relate to a wireless device, management server and methods performed therein. Furthermore, a computer program product and a computer readable storage medium are also provided herein. In particular, embodiments herein relate to determining transmission of uplink data.

### BACKGROUND

In a typical wireless communication network, wireless devices, also known as wireless communication devices, mobile stations, stations (STA) and/or user equipments (UE), communicate via a Radio Access Network (RAN) to one or more core networks (CNs). The RAN covers a geographical area which is divided into service areas or cells, with each service area or cell being served by a radio network node such as a radio access node, e.g. a Wi-Fi access point or a radio base station (RBS), which in some networks may also be denoted, for example, a NodeB (NB), an enhanced NodeB (eNodeB), or a gNodeB (gNB). The service area or cell provided by the radio network node 12 is also referred to as a wireless coverage or radio coverage. The radio network node communicates over an air interface operating on radio frequencies with the wireless device within the service area or cell.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High Speed Packet Access (HSPA) for wireless devices. In a forum known as the Third Generation Partnership Project (3GPP), telecommunications suppliers propose and agree upon standards for third generation networks, and investigate enhanced data rate and radio capacity. In some RANs, e.g. as in UTRAN, several radio network nodes may be connected, e.g. by landlines or microwave, to a controller node, such as a radio network controller (RNC) or a base station controller (BSC), which supervises and coordinates various activities of the plural radio network nodes connected thereto. This type of connection is sometimes referred to as a backhaul connection. The RNCs and BSCs are typically connected to one or more core networks.

Specifications for the Evolved Packet System (EPS), also called a Fourth Generation (4G) network, have been completed within the 3^{rd} Generation Partnership Project (3GPP) and this work continues in the coming 3GPP releases, for example to specify a Fifth Generation (5G) network. The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs. In general, in E-UTRAN/LTE the functions of an RNC are distributed between the radio network nodes, e.g. eNodeBs in LTE, and the core network. As such, the RAN of an EPS has an essentially “flat” architecture comprising radio network nodes connected directly to one or more core networks, i.e., they are not connected to RNCs. To compensate for that, the E-UTRAN specification defines a direct interface between the radio network nodes, this interface being denoted the X2 interface. New generation radio (NR) is a new radio access technology which has been specified by 3GPP in Release-15 for first release of 3GPP 5G specifications.

3GPP has specified two different air interfaces supporting for machine type communications (MTC), e.g., Internet of Things (IoT). Wireless IoT devices using 3GPP technologies may also be referred to as cellular IoT devices. In 3GPP Rel-13 (continued in Rel-14), both LTE for MTC (LTE-M), e.g., Enhanced MTC (eMTC) and Narrowband IoT (NB-IoT) wireless device types and procedures have been specified, with corresponding wireless device categories, such as Cat-M1 and Cat-M2 for eMTC and Cat-NB1 and Cat-NB2 for NB-IoT. These wireless devices may operate within a smaller bandwidth, e.g., eMTC with 6 physical resource blocks (PRBs)/1.4 MHz and NB-IoT with 1 PRB/200 kHz, and support different kinds of deployments in in-band of an existing deployment, in guard-bands of the NB-IoT or as a stand-alone system.

For both eMTC and NB-IoT one goal is to support coverage enhancement (CE). This is achieved by various different methods, where one of the methods is repetitions over time so that enough energy can be collected over time to allow the wireless device to receive the signals even in bad coverage beyond a cell edge. The repetition, e.g., for different channels may be configured by using Radio Resource Control (RRC) protocol, where a repetition factor to be used in a transmission is indicated in downlink control information (DCI) when the radio network node sends either downlink allocation or uplink grant to the UE wireless device

In telecommunications, decibels (dBs) denote signal gain or loss from a transmitter to a receiver through some medium, such as free space, waveguide, coaxial cable, fiber optics, etc. With the CE up to 164 dB maximum coupling loss (MCL) can be reached. MCL is a maximum tolerable loss in a conducted power/radio signal between a receiver and a transmitter. However the CE with higher repetition factor may use more transmission resources, e.g., longer transmission time, and therefore causes lower throughput. For instance, a maximum repetition factor for eMTC is 2048, this will result in 2048 ms total transmission time. That is, the CE will require the transmission time up to couple of seconds in the worst case.

In addition, taking a typical eMTC and NB-IoT transport block (TB) as an example, it would be few hundreds of bits. Such a size of TB combined with high repetition factor will result in low throughput, i.e., low data rates in a bad coverage. For many IoT applications, the low throughput is however not acceptable.

The cellular IoT device uses the air interface for both management operation and user data. Management operation may comprise configuration changes. Depending on a data model, the cellular IoT device may attach various metadata to the user data for describing the user data. In the disclosure herein, both the user data and the metadata will be called uplink data for the reason of simplicity. A cellular IoT device may use different data models for transmission of the uplink data. Some examples of the data models are: Sensor Measurement Lists (SenML), simple network management protocol (SNMP) management information base (MIB) modules, world wide web consortium (W3C) thing descriptions (TDs), YANG models, lightweight machine to machine (LWM2M) schemas, open connectivity foundation (OCF) schemas, and so on.

### SUMMARY

An object of embodiments herein is to provide a mechanism for improving performance of the wireless communication network. Particularly to provide a method and wireless device for determining transmission of uplink data in order to decrease power consumption by the wireless device and interference caused thereby.

According to an aspect the object is achieved by providing a method performed by a wireless device for determining transmission of uplink data. The wireless device obtains, at an application layer, information associated with a wireless coverage provided by a radio network node for the wireless device. The wireless device also determines, at the application layer, a transmission operation of uplink data based on the obtained information.

According to still another aspect the object is achieved by providing a wireless device for determining transmission of uplink data. The wireless device is configured to obtain, at an application layer, information associated with a wireless coverage provided by a radio network node for the wireless device; and determines, at the application layer, a transmission operation of uplink data based on the obtained information.

According to another aspect the object is achieved by providing a method performed by a management server for instructing a wireless device determining transmission of uplink data. The management server sends an instruction to the wireless device instructing the wireless device to obtain, at an application layer, information associated with a wireless coverage provided by a radio network node for the wireless device, and to determine, at the application layer, a transmission operation of uplink data, based on information associated with a wireless coverage provided by the radio network node for the wireless device.

According to still another aspect the object is achieved by providing a management server for instructing a wireless device determining transmission of uplink data. The management server is configured to send an instruction to the wireless device instructing the wireless device to obtain, at an application layer, information associated with a wireless coverage provided by a radio network node for the wireless device, and to determine, at the application layer, a transmission operation of uplink data, based on information associated with a wireless coverage provided by the radio network node for the wireless device.

It is furthermore provided herein a computer program product comprising instructions, which, when executed on at least one processor, cause the at least one processor to carry out any of the methods above, as performed by the wireless device or the management server. It is additionally provided herein a computer-readable storage medium, having stored thereon a computer program product comprising instructions which, when executed on at least one processor, cause the at least one processor to carry out the method according to any of the methods above, as performed by the wireless device or the management server.

The embodiments herein enable the application layer of the wireless device to dynamically determine what and how to transmit the uplink data by taking into account the information associated with the wireless coverage. By determining the transmission operation as such, power consumption by the wireless device will be decreased and longer battery life will be achieved. Additionally, interference caused by the wireless device in the network will be decreased also.

### BRIEF DESCRIPTION OF THE DRAWINGS

Embodiments will now be described in more detail in relation to the enclosed drawings, in which:

FIG. 1a is a schematic overview depicting a wireless communication network according to embodiments herein;

FIG. 1b is a schematic overview depicting a radio protocol architecture according to embodiments herein;

FIG. 2 is a flowchart depicting methods performed by a wireless device according to embodiments herein;

FIG. 3 is a block diagram depicting a wireless device according to embodiments herein;

FIG. 4 is a flowchart depicting methods performed by a management server according to embodiments herein;

FIG. 5 is a block diagram depicting a management server according to embodiments herein;

FIG. 6 schematically illustrates a telecommunication network connected via an intermediate network to a host computer;

FIG. 7 is a generalized block diagram of a host computer communicating via a base station with a user equipment over a partially wireless connection;

FIG. 8-FIG. 11 are flowcharts illustrating methods implemented in a communication system including a host computer, a base station and a user equipment.

### DETAILED DESCRIPTION

As part of developing embodiments herein, a problem will first be identified and shortly discussed.

The conventional application running at the wireless device is not aware when it would be good enough to attach the metadata to the user data, and when it would be better to not include such metadata. For instance, if the application transmits uplink data during a bad coverage level, a stronger power is required, and more power is consumed by the wireless device than a good coverage level. It means that the battery life of wireless device will be shortened in this case. Meanwhile, interference will also be introduced by the transmission in stronger power. To achieve better battery life for the wireless device and less interference in the wireless communication network it would be advantageous to dynamically adapt transmission of the uplink data to the coverage level.

The embodiments here enable the application layer of the wireless device to dynamically determine what and how to transmit the uplink data by taking into account the information associated with the wireless coverage. By determining the transmission operation as such, power consumption by the wireless device will be decreased and longer battery life will be achieved. Additionally, interference caused by the wireless device in the network will be decreased also. For instance, the application layer of the wireless device may determine to not send any or send only a part of metadata when the coverage level is not good, accordingly throughput is improved. By sending a part of the metadata, in good coverage level the metadata can be used to the advantage of the application.

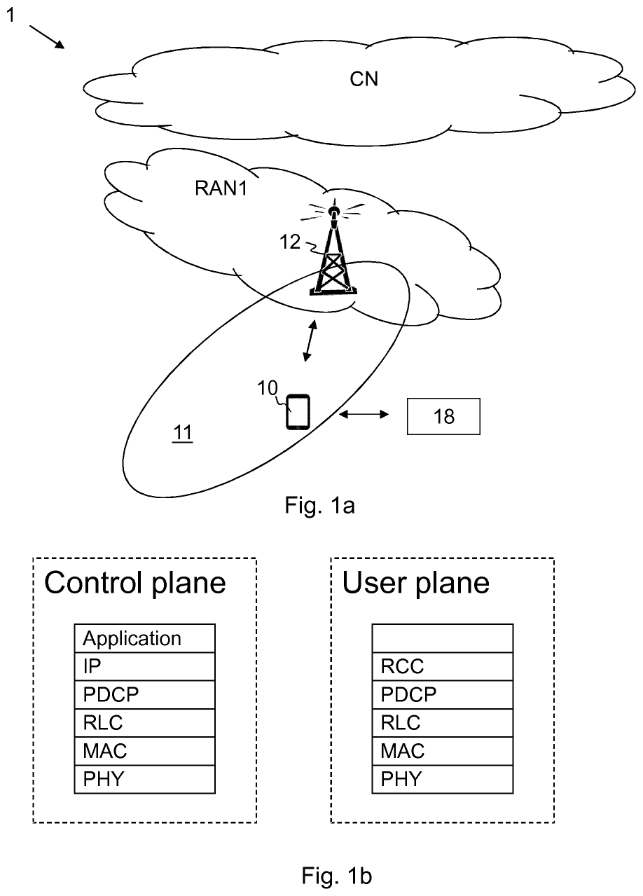

FIG. 1a is a schematic overview depicting a wireless communication network 1 comprising one or more RANs, e.g. a first RAN (RANI), connected to one or more CNs, e.g. a 5G core network (5GCs). The wireless communication network 1 may use one or more technologies, such as Wi-Fi, Long Term Evolution (LTE), LTE-Advanced, New Radio (NR), Wideband Code Division Multiple Access (WCDMA), Global System for Mobile communications/Enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in, e.g., a LTE or a NR context, however, embodiments are applicable also in further development of the existing communication systems such as e.g. GSM or UMTS.

In the wireless communication network 1, wireless devices, e.g. a wireless device 10 such as a mobile station, a non-access point (non-AP) station (STA), a STA, a user equipment (UE) and/or a wireless terminal, are connected via the one or more RANs, to the one or more CNs, e.g. 5GCs. It should be understood by those skilled in the art that “wireless device” is a non-limiting term which means any terminal, wireless communication terminal, communication equipment, machine type communication (MTC) device, cellular IoT device, device to device (D2D) terminal, or user equipment e.g. smart phone, laptop, mobile phone, sensor, relay, mobile tablets or any device communicating within a cell or service area. The wireless device searches for carriers using a carrier raster. The carrier raster indicating possible frequency positions of a carrier for the wireless device

The wireless communication network 1 comprises a radio network node 12. The radio network node 12 is exemplified herein as a RAN node providing radio coverage over a geographical area, a service area 11, of a radio access technology (RAT), such as NR, LTE, UMTS, Wi-Fi or similar. The radio network node 12 may be a radio access network node such as an access point, e.g. a wireless local area network (WLAN) access point or an Access Point Station (AP STA), an access controller. Examples of the radio network node 12 may also be a NodeB, a gNodeB, an evolved Node B (eNB, eNodeB), a base transceiver station, Access Point Base Station, base station router, a transmission arrangement of a radio network node, a stand-alone access point or any other network unit capable of serving a wireless device 10 within the service area served by the radio network node 12 depending e.g. on the radio access technology and terminology used and may be denoted as a receiving radio network node.

The wireless communication network 1 may also comprise a management server 18 which instructs or configures the wireless device 10 to perform the embodiments herein performed by the wireless device 10. An example of the management server 18 comprises an LwM2M server, in this case the wireless device 10 is regarded as an LwM2M client.

As shown in FIG. 1b, a radio protocol architecture for wireless communication may be separated into control plane and user plane. At user plane, an application layer is above all other layers. Applications at an application layer may create data packets that will be processed by protocols such as Transmission Control Protocol (TCP), User Datagram Protocol (UDP) and Internet Protocol (IP), while in the control plane, the radio resource control (RRC) protocol may write the signalling messages that are exchanged between the radio network node 12 and the wireless device 10. In both planes, the information may be processed by a radio protocol stack comprising, e.g., packet data convergence protocol (PDCP), a radio link control (RLC) protocol and a medium access control (MAC) protocol, before being passed to a physical (PHY) layer for transmission. The radio protocol stack refers to an Access Stratum, that is, the protocols therein are between the wireless device and the radio network node. On the other hand, application layer protocols are end-to-end, they are (typically) between a device and an application server or cloud. In principle, the radio protocol stack may also be referred to as a lower layer relative to the application layer.

Application at the application layer may also be referred to as software application, or application layer software, such as a software sending measurement reports. The application at the application layer is normally a separate software from the one in a radio modem of the UE running protocols at the radio protocol stack.

The wireless coverage level, also referred to a coverage level, may be classified at the application layer as a qualitative level, e.g., good or bad or so on. The coverage level may be determined based on one or more thresholds of the signal strength. When the signal strength of a received signal meets certain one or more thresholds the corresponding coverage level is assigned. In other words, depending on, e.g., the signal strength, the coverage level may be abstracted or classified at the application layer as excellent, good, reasonable, bad etc. For instance, the application layer of a wireless device 10 at a cell edge normally receives relative poor signals from the radio network node 12, the coverage level is thus regarded as bad at the application layer.

On the hand, a coverage level may also be classified or indicated by the radio protocol stack as different numbers, e.g., CE level 0, 1, 2 . . . , or as different repetition factors for transmissions (i.e. repetitions of subframes, physical signals or channels). For example, the repetition factor for uplink data transmission may be used as an indirect indication of coverage level at radio protocol stack, which could then be mapped to a coverage level at the application layer.

The coverage level at the radio protocol stack may have a one to one correspondence with the one at the application layer. However it is not always necessary. The coverage level at the application layer may be something more general compared to the coverage level according to the radio protocol stack. For example, two coverage levels at the radio protocol stack, e.g., CE levels 0 and 1, correspond to one coverage level at the application layer, e.g., bad.

The classifying of the coverage level at the application layer and the radio protocol stack, and the correspondence thereof are configured according to design options. The embodiments herein refer to the coverage level at the application layer except for explicitly specifying the radio protocol stack.

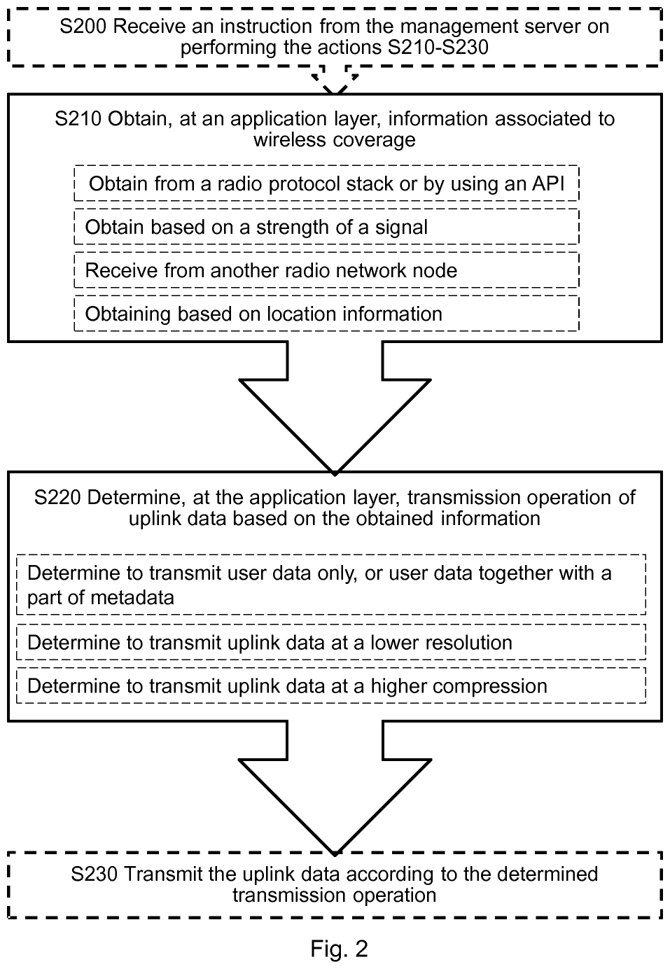

FIG. 2 is a flowchart describing an exemplary method performed by the wireless device 10 for determining transmission of uplink data. The method may be configured by the management server 18. The following actions may be taken in any suitable order. Actions that could be performed only in some embodiments may be marked with dashed boxes.

Action S200. The wireless device 10 may receive an instruction from the management server 18 specifying the method performed by the wireless device 10 for determining transmission of uplink data, i.e., specifying to perform the following actions S210-S230.

Action S210. The wireless device 10 obtains, at an application layer, information associated with a wireless coverage provided by the radio network node 12 for the wireless device 10.

As mentioned above, wireless coverage refers to a service area or cell. If the wireless device 10 is located closer to the radio network node 12, the wireless device 10 may normally have a good coverage level, whereas the wireless device 10 located further away from, e.g., at the edge of, the radio network node 12, may have a bad coverage level.

The information associated with the wireless coverage is for indicating or specifying the coverage level, e.g., excellent, good, reasonable, bad, provided by the radio network node 12 for the wireless device 10. It may be any information from which one may derive the coverage level.

As an example, the information associated with the wireless coverage may be a repetition factor associated with a coverage enhancement, which may be configured locally or received from the radio network node 12 in a DCI. When the wireless coverage is bad the repetition factor is increased, and in good coverage a smaller repetition factor may be used.

The information associated with the wireless coverage may also be strength of a signal received by the wireless device 10 or received by the radio network node 12. The strength of the signal may be measured by the wireless device 10 and indicated by a reference signal received power (RSRP), reference signal received quality (RSRQ) or any other indications of signal level or quality. Knowing the measured strength of the received signal, the wireless device 10 may map, at the application layer, the measured strength to the coverage level. For example, measured RSRP values over X dB may be mapped to the good coverage level and measured RSRP values less or equal than X dB may be mapped to bad coverage level;

The information associated with the wireless coverage may also be a cell selection criterion, e.g., Cell selection criterion S. Cell selection refers to a feature wherein the wireless device 10 selects a cell to which the wireless device camps on (register). The cell selection would be influenced by several factors including whether or not a radio network node transmits power strong enough to be recognized or detected by the wireless device 10, i.e., signal strength or quality criteria. Taking LTE-M as an example, if the wireless device 10 doesn't fulfil the cell selection criteria for normal coverage, the wireless device 10 may fulfil cell criteria for enhanced coverage, either for CE Mode A or CE Mode B.

More details of the CE Mode A and CE Mode B can be found in 3GPP R1-156401, Final Report of RAN1#82bis meeting. Thus knowing if the cell selection criterion is fulfilled either for normal coverage or for enhanced coverage, the wireless device 10 is also able to, at the application layer, determine a current coverage level. To obtain an optimal coverage level, the current coverage level may be used in combination with the strength of the signal received by the wireless device 10 or received by the radio network node 12 as discussed above.

The information associated with the wireless coverage may also be a coverage enhancement (CE) mode that the wireless device 10 is running on. The wireless device 10 may be configured with different CE modes, e.g., CE Mode A and CE Mode B. Being aware of the CE mode may also allow the wireless device 10 to determine the coverage level at the application layer. For instance, a good coverage level is corresponding to the CE Mode A, a bad coverage level is corresponding to the CE Mode B. That is because each CE mode may define one or more coverage levels corresponding to repetition factors, i.e., repetition numbers. For instance the CE Mode A may refer to coverage levels with no repetitions or a small number of repetitions, and the CE Mode B may refer to coverage levels requiring medium and large number of repetitions. The small number, medium and large number are design options, and may be configured according to common practice in the art.

The information associated with the wireless coverage may also be location information of the wireless device 10. The coverage level may be obtained from a database or a data structure which contain correspondence between earlier measured locations and coverage levels.

With respect to the above different information associated with the wireless coverage, the wireless device 10 may obtain, at the application layer of the wireless device 10, the information associated with the wireless coverage in different ways.

The application layer may obtain from a radio protocol stack or by using an Application Programming Interface (API) at least one of: a coverage level e.g., in case of LTE-M, a repetition factor associated with coverage enhancement e.g., in case of NB-IoT, a cell selection criterion, a coverage enhancement mode that the wireless device 10 is running, or information associated with a wireless coverage used for previous transmission of uplink data.

Other possible ways may also be used, e.g., when obtaining the information from the API or the radio protocol stack is not available or possible.

For instance, the application layer may obtain the repetition factor associated with coverage enhancement based on strength of a signal which is received by the wireless device 10 or received by the radio network node 12. In this case, the wireless device 10 may use a separate co-located receiver module to estimate the strength, e.g., power, of the received signal.

The application layer may receive the information associated with the wireless coverage from another radio network node, e.g., an eNB, gNB, Mobility Management Entity (MME), User Plane Function (UPF), Access & Mobility management Function, Session Management Function (SMF) etc. This can be implemented by using a signalling defined for this purpose between the wireless device 10 and another radio network node.

The application layer may obtain the information associated with the wireless coverage based on location information of the wireless device 10.

Alternatively, the wireless device 10 may also assume the same coverage level used in one or more previous transmissions if one or more transmission characteristics can be assumed to be similar e.g., because the transmission happens in the same location towards the same radio network node, e.g. eNB, gNB, and close to the time of the first transmission. This applies particularly to, e.g., in the case that the wireless device 10 is stationary.

Action S220. The wireless device 10 determines, at the application layer, a transmission operation of uplink data based on the obtained information.

The uplink data may comprise user data and metadata describing the user data. The metadata may provide any information about the user data. Many distinct types of metadata exist, among these descriptive metadata, structural metadata, administrative metadata, reference metadata and statistical metadata. Some metadata may be not compulsory but helpful for the application. However metadata may be helpful for example to describe the context of the user data more accurately.

The transmission operation may refer to how, i.e., whether or not and to what extent metadata is transmitted together with user data. E.g., transmit user data only without any metadata, a part of metadata together with user data, or all metadata together with user data. Alternatively or additionally, the transmission operation may refer to how to transmit the uplink data, e.g., transmit at a higher or lower compression; transmit at a higher or lower resolution, or transmit at a higher precision.

The determining of the transmission operation refers to determining any one or more of the above operations.

For instance, the application layer may determine to transmit the user data only without any metadata, when the information indicates a coverage level which is below a threshold. One example of such metadata is SenML link that provides a pointer to additional information of a SenML Record. The SenML link adds commonly some tens of bytes extra payload for each Record that uses it. If this information is not strictly needed, the application may determine to omit it if that enables fitting the resulting payload better to underlying radio frames. Determining not to transmit the metadata would optimize power consumption by the wireless device 10 and radio resource usage.

As mentioned above, the coverage level may be configured as at least two categories, such as excellent, good, reasonable, bad etc. Accordingly the threshold may be configured as, e.g., reasonable. For the reason of simplicity, the embodiments herein will be discussed in the context of the above example, however the embodiments are applicable also in any other configuration of the coverage level and the threshold.

Alternatively, the application layer may determine to transmit the user data together with a part of the metadata when the information indicates a coverage level which is below a threshold. The part of the metadata determined to be transmitted may have a higher priority than the remaining metadata. Configuring the priority may be performed by the application. For example, priority may be configured per type of the metadata, some types of metadata would be configured with higher priority. Some metadata is not necessary to be sent every time, and a receiving application may have some requirements when to have the metadata available. In such cases, the application layer may also configure a higher priority for metadata which has not been transmitted after a period, so that the application may determine to transmit the metadata even though the coverage is below a threshold.

On the other hand, the application layer may configure a lower priority for metadata which has been recently transmitted, in this case the application layer may determine not to transmit such metadata even in the good coverage level.

Alternatively, the application layer may determine to transmit data derived from the user data and the metadata when the information indicates a coverage which is above a threshold. For instance, the user data and the metadata are a base value and a supplementary value, respectively. When the information indicates a coverage which is above a threshold, i.e., good coverage level, the wireless device 10 may determine to transmit a sum or a concatenated result of the user data and the metadata. By doing so, the processing in an edge and cloud components of the wireless communication network 1 will be facilitated, though at the expense of higher data use.

Alternatively or additionally, the application layer may determine to transmit the uplink data at a lower resolution when the information indicates a coverage level which is below a threshold.

Alternatively or additionally, the application layer may determine to transmit the uplink data at a higher compression at the cost of higher processing complexity when the information indicates a coverage level which is below a threshold. For example, the Efficient XML Interchange (EXI) may be used, e.g., instead of JavaScript Object Notation (JSON) encoding of SenML in low coverage.

Alternatively or additionally, the application layer may determine to transmit the uplink data at a higher precision. For instance, some user data which extends digital length of another user data, could help with providing more accurate results by increasing the amount of numbers in decimal representation of the user data. In this case, the application layer may determine to transmit the concatenate of the two use data directly. Thereby the computation complexity at the receiving side will be decreased.

Action S230. The wireless device 10 may transmit the uplink data according to the determined transmission operation.

The embodiments herein provide a method for the application layer of the wireless device 10 to dynamically alter the transmission operation based on the information associated with the wireless coverage of the radio network node 12 provided for the wireless device 10.

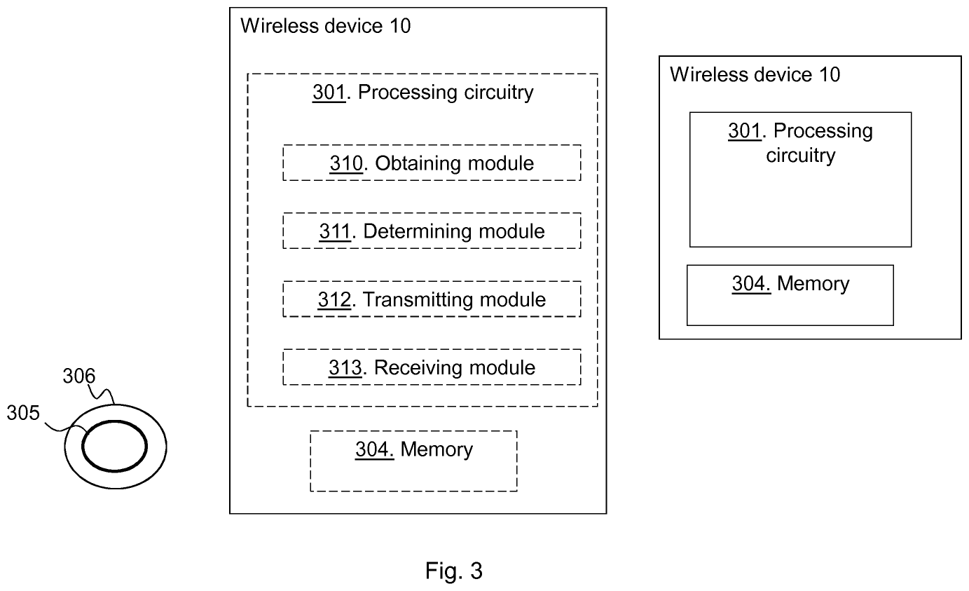

FIG. 3 is a block diagram depicting the wireless device 10 for determining transmission of uplink data according to embodiments herein.

The wireless device 10 may comprise processing circuitry 301, e.g. one or more processors, configured to perform the methods herein.

The wireless device 10 may comprise a receiving module 313. The wireless device 10, the processing circuitry 301, and/or the receiving module 313 is configured to receive the instruction from a management server 18 instructing the wireless device 10 to perform the method for determining transmission of uplink data.

The wireless device 10 may comprise an obtaining module 310. The wireless device 10, the processing circuitry 301, and/or the obtaining module 310 is configured to obtain, at the application layer, the information associated with a wireless coverage provided by a radio network node 12 for the wireless device 10.

For instance, the wireless device 10, the processing circuitry 301, and/or the obtaining module 310 is configured to obtain, at the application layer of the wireless device 10, the information associated with the wireless coverage by being configured to perform at least one of: obtaining from a radio protocol stack at least one of: a coverage level, a repetition factor associated with coverage enhancement, a cell selection criterion, a coverage enhancement mode that the wireless device 10 is running, or information associated with a wireless coverage used for previous transmission of uplink data; obtaining the repetition factor associated with coverage enhancement based on a strength of a signal received by the wireless device 10 or received by the radio network node 12; receiving the information associated with the wireless coverage from another wireless device 10; or obtaining the information associated with the wireless coverage based on location information of the wireless device 10.

The wireless device 10 may comprise a determining module 311. The wireless device 10, the processing circuitry 301, and/or the determining module 311 is configured to determine, at the application layer, the transmission operation of the uplink data based on the obtained information.

For instance, the wireless device 10, the processing circuitry 301, and/or the determining module 311 may be configured to determine, at the application layer, the transmission operation of uplink data by being configured to determine to transmit the user data only, or the user data together with a part of the metadata w, to transmit the uplink data at a lower resolution, and/or to transmit the uplink data at a higher compression, when the information indicates a coverage which is below the threshold.

The wireless device 10 may further comprise a transmitting module 312, e.g., a transceiver or transmitter. The wireless device 10, the processing circuitry 301, and/or the transmitting module 302 may be configured to transmit the uplink data according to the determined transmission operation.

The wireless device 10 may further comprise a memory 304. The memory comprises one or more units to be used to store data on, such as the inputs, outputs, thresholds, time period and/or the related parameters to perform the methods disclosed herein when being executed. Thus, the wireless device 10 may comprise the processing circuitry 301 and the memory 304, said memory 304 comprising instructions executable by said processing circuitry 301 whereby said wireless device 10 is operative to perform the methods herein.

The methods according to the embodiments described herein for the wireless device 10 are respectively implemented by means of e.g. a computer program product 305 or a computer program 305, comprising instructions, i.e., software code portions, which, when executed on at least one processor, cause the at least one processor to carry out the actions described herein, as performed by the wireless device 10. The computer program product 305 may be stored on a computer-readable storage medium 306, e.g. a disc, USB or similar. The computer-readable storage medium 306, having stored thereon the computer program product 305, may comprise the instructions which, when executed on at least one processor, cause the at least one processor to carry out the actions described herein, as performed by the wireless device 10. In some embodiments, the computer-readable storage medium may be a non-transitory computer-readable storage medium.

As will be readily understood by those familiar with communications design, that functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device 10, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of wireless devices will appreciate the cost, performance, and maintenance trade-offs inherent in these design choices.

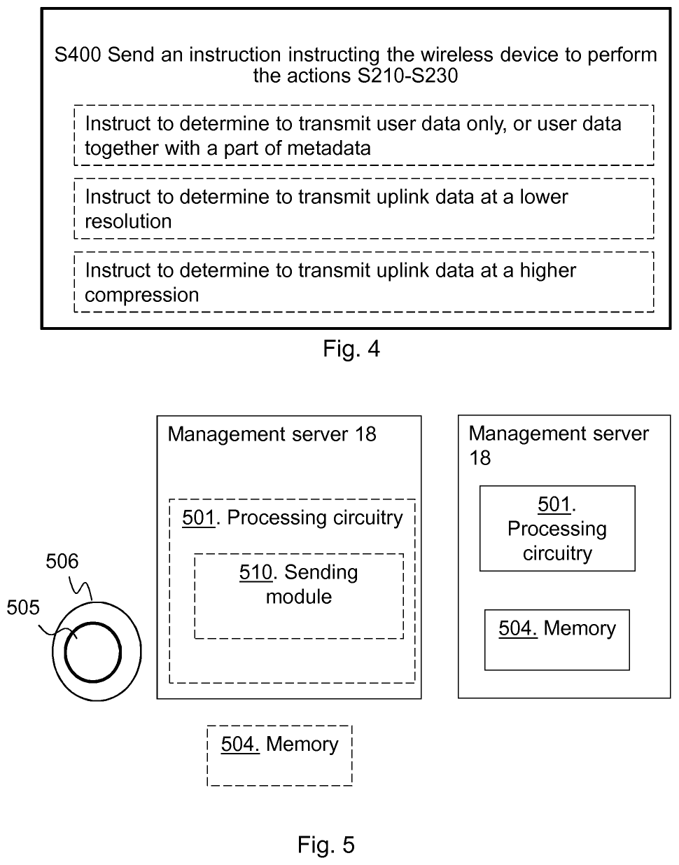

FIG. 4 is a flowchart depicting methods performed by the management server 18 for instructing the wireless device 10 determining transmission of uplink data according to some embodiments herein.

Action 400. The management server 18 may send the instruction to the wireless device 10 instructing the wireless device 10 to obtain, at the application layer, the information associated with the wireless coverage provided by the radio network node 12 for the wireless device 10, and to determine, at the application layer, the transmission operation of uplink data, based on information associated with a wireless coverage provided by the radio network node 12 for the wireless device 10.

The instruction may instruct the wireless device 10 to determine to transmit the user data only, or the user data together with a part of the metadata when the information indicates a wireless coverage level which is below a threshold. The instruction may instruct the wireless device 10 to configure the part of the metadata with a higher priority than the remaining metadata.

The instruction may instruct the wireless device 10 to determine to transmit the uplink data at a lower resolution when the information indicates a wireless coverage level which is below a threshold.

The instruction may instruct the wireless device 10 to determine to transmit the uplink data at a higher compression when the information indicates a wireless coverage level which is below a threshold.

The instruction may instruct the wireless device 10 to perform at least one of:
obtaining from a radio protocol stack or by using an Application Programming Interface (API) at least one of: a coverage level, a repetition factor associated with coverage enhancement, a cell selection criterion, a coverage enhancement mode that the wireless device 10 is running, or information associated with a wireless coverage used for previous transmission of uplink data;
obtaining the repetition factor associated with coverage enhancement based on strength of a signal received by the wireless device 10 or received by the radio network node 12;
receiving the information associated with the wireless coverage from another radio network node; or
obtaining the information associated with the wireless coverage based on location information of the wireless device 10.

FIG. 5 is a block diagram depicting the management server 18 for instructing a wireless device 10 determining transmission of uplink data according to embodiments herein.

The management server 18 may comprise processing circuitry 501, e.g. one or more processors, configured to perform the methods herein.

The management server 18 comprises a sending module 510. The management server 18, the processing circuitry 501, and/or the sending module 510 may be configured to send the instruction to the wireless device 10 instructing the wireless device 10 to obtain, at the application layer, the information associated with a wireless coverage provided by a radio network node 12 for the wireless device 10, and to determine, at the application layer, the transmission operation of uplink data, based on information associated with a wireless coverage provided by the radio network node 12 for the wireless device 10.

The management server 18 may further comprise a memory 504. The memory comprises one or more units to be used to store data on, such as the inputs, outputs, thresholds, time period and/or the related parameters to perform the methods disclosed herein when being executed. Thus, the management server 18 may comprise the processing circuitry 501 and the memory 504, said memory 504 comprising instructions executable by said processing circuitry 501 whereby said management server 18 is operative to perform the methods herein.

The methods according to the embodiments described herein for the management server 18 are respectively implemented by means of e.g. a computer program product 505 or a computer program, comprising instructions, i.e., software code portions, which, when executed on at least one processor, cause the at least one processor to carry out the actions described herein, as performed by the management server 18. The computer program product 505 may be stored on a computer-readable storage medium 506, e.g. a disc, USB or similar. The computer-readable storage medium 506, having stored thereon the computer program product 505, may comprise the instructions which, when executed on at least one processor, cause the at least one processor to carry out the actions described herein, as performed by the management server 18. In some embodiments, the computer-readable storage medium may be a non-transitory computer-readable storage medium.

As will be readily understood by those familiar with communications design, that functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a management server 18, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of wireless devices will appreciate the cost, performance, and maintenance trade-offs inherent in these design choices.

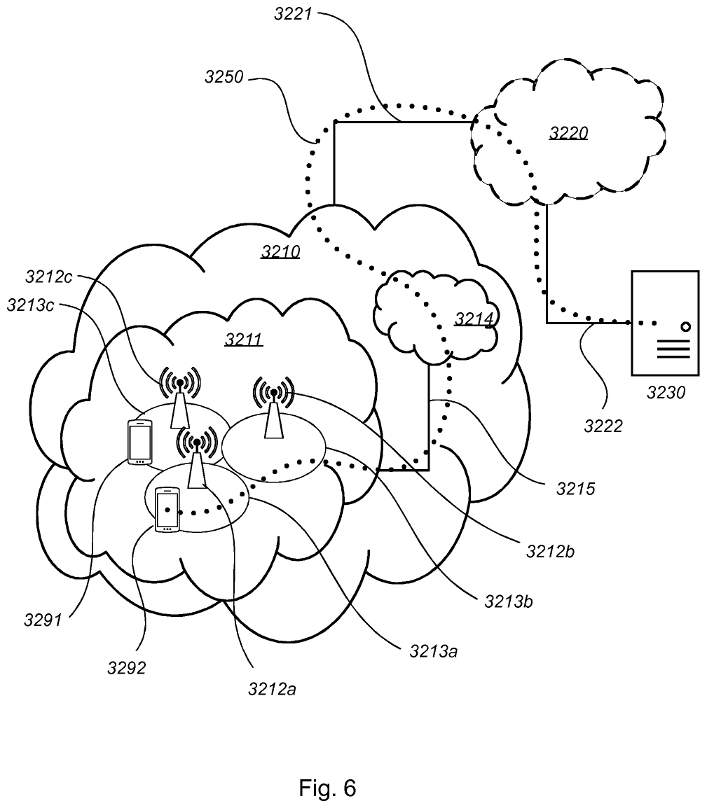

With reference to FIG. 6, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network nodes herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the wireless device 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 6 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g. handed over) to a connected UE 3291. Similarly, the base station 3212 need not be aware of the future routing of an outgoing uplink communication originating from the UE 3291 towards the host computer 3230.

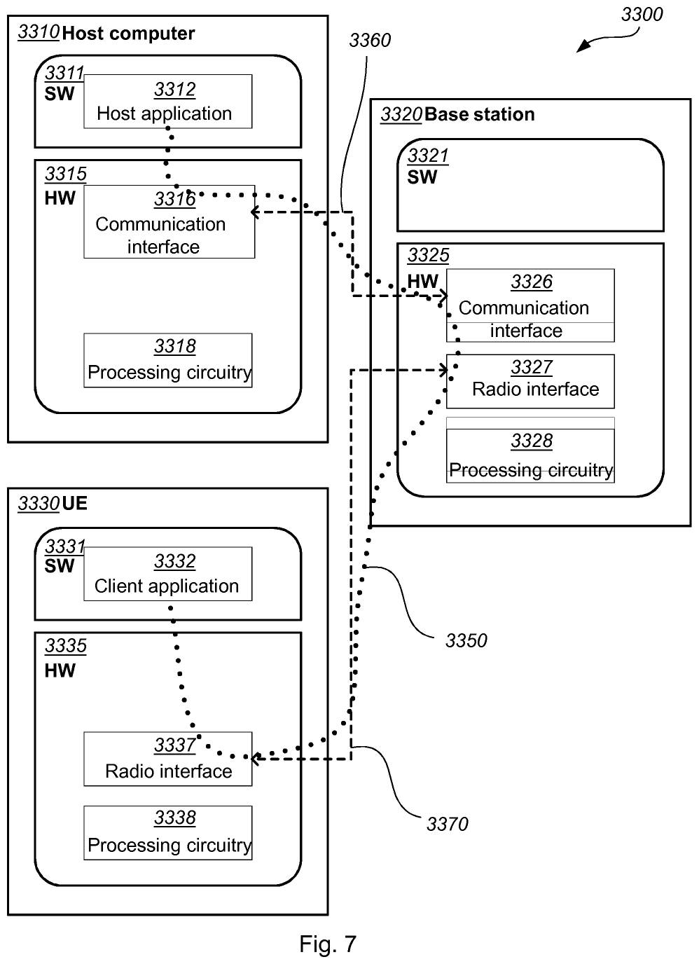

Example implementations, in accordance with an embodiment, of the UE, base station and host computer discussed in the preceding paragraphs will now be described with reference to FIG. 7. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 7) served by the base station 3320. The communication interface 3326 may be configured to facilitate a connection 3360 to the host computer 3310. The connection 3360 may be direct or it may pass through a core network (not shown in FIG. 7) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 7 may be identical to the host computer 3230, one of the base stations 3212a, 3212b, 3212c and one of the UEs 3291, 3292 of FIG. 6, respectively. This is to say, the inner workings of these entities may be as shown in FIG. 7 and independently, the surrounding network topology may be that of FIG. 6.

In FIG. 7, the OTT connection 3350 has been drawn abstractly to illustrate the communication between the host computer 3310 and the user equipment 3330 via the base station 3320, without explicit reference to any intermediary devices and the precise routing via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g. on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may decrease the power consumption by the UE and thereby prolong longer battery life and decrease interference.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

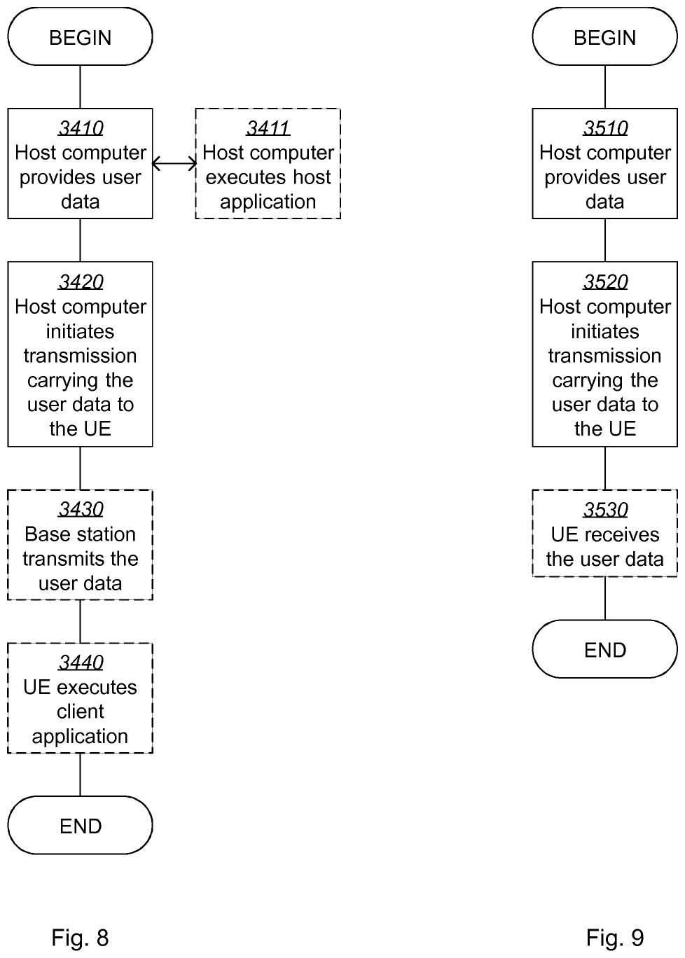

FIG. 8 is a flowchart illustrating a method implemented in a communication system, in accordance with one embodiment. The communication system includes a host computer, a base station and a UE which may be those described with reference to FIG. 6 and FIG. 7. For simplicity of the present disclosure, only drawing references to FIG. 8 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 9 is a flowchart illustrating a method implemented in a communication system, in accordance with one embodiment. The communication system includes a host computer, a base station and a UE which may be those described with reference to FIG. 6 and FIG. 7. For simplicity of the present disclosure, only drawing references to FIG. 9 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

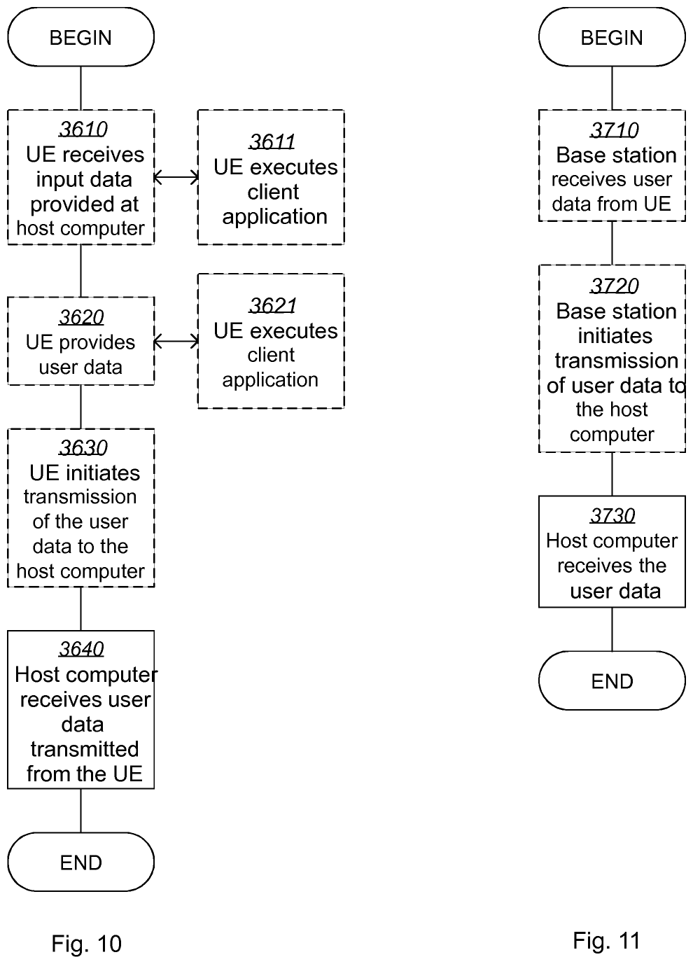

FIG. 10 is a flowchart illustrating a method implemented in a communication system, in accordance with one embodiment. The communication system includes a host computer, a base station and a UE which may be those described with reference to FIG. 6 and FIG. 7. For simplicity of the present disclosure, only drawing references to FIG. 10 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 11 is a flowchart illustrating a method implemented in a communication system, in accordance with one embodiment. The communication system includes a host computer, a base station and a UE which may be those described with reference to FIG. 6 and FIG. 7. For simplicity of the present disclosure, only drawing references to FIG. 11 will be included in this section. In an optional first step 3710 of the method, in accordance with the teachings of the embodiments described throughout this disclosure, the base station receives user data from the UE. In an optional second step 3711, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1-22. (canceled)

23. A method, performed by a wireless device, for determining transmission of uplink data; the method comprising the wireless device:
obtaining, at an application layer, information associated with a wireless coverage provided by a radio network node for the wireless device; and
determining, at the application layer, a transmission operation of uplink data based on the obtained information.

24. The method of claim 23, wherein the uplink data comprises user data and metadata describing the user data.

25. The method of claim 24, wherein the determining, at the application layer, the transmission operation of uplink data based on the information comprises determining to transmit the user data only, or the user data together with a part of the metadata, when the information indicates a wireless coverage level which is below a threshold.

26. The method of claim 23, wherein the determining, at the application layer, the transmission operation of uplink data based on the information comprises determining to transmit the uplink data at a lower resolution when the information indicates a wireless coverage level which is below a threshold.

27. The method of claim 23, wherein the determining, at the application layer, the transmission operation of uplink data based on the information comprises determining to transmit the uplink data at a higher compression when the information indicates a wireless coverage level which is below a threshold.

28. The method of claim 23, wherein the information associated with the wireless coverage comprises:
a repetition factor associated with coverage enhancement;
a strength of a signal received by the wireless device or received by the radio network node;
cell selection criterion for normal and/or enhanced coverage;
a coverage enhancement mode that the wireless device is running; and/or location information of the wireless device.

29. The method of claim 23, wherein the obtaining, at the application layer of the wireless device, the information associated with the wireless coverage comprises:
obtaining, from a radio protocol stack or by using an Application Programming Interface (API):
a coverage level;
a repetition factor associated with coverage enhancement;
a cell selection criterion;
a coverage enhancement mode that the wireless device is running; and/or information associated with a wireless coverage used for previous transmission of uplink data;
obtaining the repetition factor associated with coverage enhancement based on a strength of a signal received by the wireless device or received by the radio network node;
receiving the information associated with the wireless coverage from another radio network node; and/or
obtaining the information associated with the wireless coverage based on location information of the wireless device.

30. The method of claim 23, further comprising transmitting the uplink data according to the determined transmission operation.

31. The method of claim 23, further comprising receiving an instruction from a management server instructing the wireless device to perform the method for determining transmission of the uplink data.

32. A method, performed by a management server, for instructing a wireless device to determine transmission of uplink data; the method comprising the management server:
sending an instruction to the wireless device instructing the wireless device to:
obtain, at an application layer, information associated with a wireless coverage provided by a radio network node for the wireless device; and
determine, at the application layer, a transmission operation of uplink data, based on information associated with a wireless coverage provided by the radio network node for the wireless device.

33. The method of claim 32, wherein the uplink data comprises user data and metadata describing the user data.

34. The method of claim 33, wherein the instruction instructs the wireless device to determine to transmit the user data only, or the user data together with a part of the metadata, when the information indicates a wireless coverage level which is below a threshold.

35. The method of claim 34, wherein the instruction instructs the wireless device to configure the part of the metadata with a higher priority than the remaining metadata.

36. The method of claim 32, wherein the instruction instruct the wireless device to, when the information indicates a wireless coverage level which is below a threshold:
determine to transmit the uplink data at a lower resolution; or
determine to transmit the uplink data at a higher compression.

37. The method of claim 32, wherein the information associated with the wireless coverage comprises:
a repetition factor associated with coverage enhancement;
a strength of a signal received by the wireless device or received by the radio network node by the radio network node;
cell selection criterion for normal and/or enhanced coverage;
a coverage enhancement mode that the wireless device is running; and/or
location information of the wireless device.

38. The method of claim 32, wherein the instruction instructs the wireless device to:
obtain, from a radio protocol stack or by using an Application Programming Interface (API):
a coverage level;
a repetition factor associated with coverage enhancement;
a cell selection criterion;
a coverage enhancement mode that the wireless device is running; and/or
information associated with a wireless coverage used for previous transmission of uplink data;
obtain the repetition factor associated with coverage enhancement based on a strength of a signal received by the wireless device or received by the radio network node;
receive the information associated with the wireless coverage from another radio network node; and/or
obtain the information associated with the wireless coverage based on location information of the wireless device.

39. A wireless device for determining transmission of uplink data, the wireless device comprising:
processing circuitry;
memory containing instructions executable by the processing circuitry whereby the wireless device is operative to:
obtain, at an application layer, information associated with a wireless coverage provided by a radio network node for the wireless device; and
determine, at the application layer, a transmission operation of uplink data based on the obtained information.

40. A management server for instructing a wireless device determining transmission of uplink data, the management server comprising:
processing circuitry;
memory containing instructions executable by the processing circuitry whereby the management server is operative to send an instruction to the wireless device instructing the wireless device to:
obtain, at an application layer, information associated with a wireless coverage provided by a radio network node for the wireless device; and
determine, at the application layer, a transmission operation of uplink data, based on information associated with a wireless coverage provided by the radio network node for the wireless device.
